(19) United States
(12) Patent Application Publication
(10) Pub. No.: US 2025/0373169 A1
(43) Pub. Date: Dec. 4, 2025

(54) CIRCUITS AND METHODS TO OPERATE POWER CONVERTERS WITH FULL RING VALLEY SWITCHING

(71) Applicant: Navitas Semiconductor Limited, Dublin (IE)

(72) Inventors: Zhenxu ZHA, Shanghai (CN); Changhu YU, Shanghai (CN); Yinshi YU, Shanghai (CN)

(73) Assignee: Navitas Semiconductor Limited, Dublin (IE)

(21) Appl. No.: 19/227,140

(22) Filed: Jun. 3, 2025

(30) Foreign Application Priority Data
Jun. 3, 2024 (CN) 202410710739.5

(51) Int. Cl. H02M 3/335; H02M 3/00

(52) U.S. Cl. CPC H02M 3/33571; H02M 3/01

(57) ABSTRACT

A circuit is disclosed. The circuit includes a transformer having a primary winding and a secondary winding, the primary winding extending from a first terminal to a second terminal, a first switch having a first source terminal and a first drain terminal, the first drain terminal connected to the first terminal, a second switch having a second source terminal and a second drain terminal, the second source terminal connected to the second terminal, and the second drain terminal connected to the first source terminal at a switch node, and a controller circuit connected to the switch node and arranged to sense a voltage at the switch node, compare the sensed voltage to a predetermined threshold, increase an on-time of the first switch when the sensed voltage is less than the predetermined threshold, and decrease the on-time of the first switch when the sensed voltage is greater than the predetermined threshold.

### CROSS REFERENCE TO RELATED APPLICATIONS

This application claims priority to China provisional patent application no. 202410710739.5, for “CONTROL FULL RING IN VALLEY SWITCHING” filed on Jun. 3, 2024, which is hereby incorporated by reference in entirety for all purposes.

### FIELD

The described embodiments relate generally to power converters, and more particularly, the present embodiments relate to circuits and methods to operate power converters with full ring valley switching.

### BACKGROUND

Electronic devices such as computers, servers and televisions, among others, employ one or more electrical power conversion circuits to convert one form of electrical energy to another. Some electrical power conversion circuits convert a high (or low) DC voltage to a lower (or higher) DC voltage using a circuit topology called DC-DC converter. As many electronic devices are sensitive to size and efficiency of the power conversion circuit, new power converters can provide relatively higher efficiency and lower size for the new electronic devices.

### SUMMARY

In some embodiments, a circuit is disclosed. The circuit includes a transformer having a primary winding and a secondary winding, the primary winding extending from a first terminal to a second terminal; a first switch having a first gate terminal, a first source terminal and a first drain terminal, the first drain terminal connected to the first terminal; a second switch having a second gate terminal, a second source terminal and a second drain terminal, the second source terminal connected to the second terminal, and the second drain terminal connected to the first source terminal at a switch node; and a controller circuit connected to the switch node and arranged to: sense a voltage at the switch node; compare the sensed voltage to a predetermined threshold; increase an on-time of the first switch when the sensed voltage is less than the predetermined threshold; and decrease the on-time of the first switch when the sensed voltage is greater than the predetermined threshold.

In some embodiments, the circuit further includes a capacitor connected between the second drain terminal and the second terminal.

In some embodiments, a first terminal voltage is indicated by Vin, a resonant switch node voltage is indicated by Vsw and a capacitor voltage is indicated by Vcr, where the controller circuit is further arranged to keep Vsw between Vin and Vin−2Vcr.

In some embodiments, the controller circuit includes a switch node detection circuit and a switch on-time control circuit.

In some embodiments, the switch node detection circuit is arranged to generate a first signal based on the comparison and transmit the first signal to the switch on-time control circuit.

In some embodiments, the transformer further includes an auxiliary winding having a first end and a second end, where the first end is connected to a ground and the second end is connected to a resistor network.

In some embodiments, the resistor network is arranged to generate a feedback signal that corresponds to the voltage at the switch node.

In some embodiments, the feedback signal is transmitted to the controller circuit and where the controller circuit generates the on-time of the first switch based on the feedback signal.

In some embodiments, a method operating a circuit is disclosed. The method includes providing a transformer having a primary winding and a secondary winding, the primary winding extending from a first terminal to a second terminal; providing a first switch having a first gate terminal, a first source terminal and a first drain terminal, the first drain terminal connected to the first terminal; providing a second switch having a second gate terminal, a second source terminal and a second drain terminal, the second source terminal connected to the second terminal, and the second drain terminal connected to the first source terminal at a switch node; and sensing, by a controller circuit, a voltage at the switch node; comparing, by the controller circuit, the sensed voltage to a predetermined threshold; increasing an on-time of the first switch, by the controller circuit, when the sensed voltage is less than the predetermined threshold; and decrease the on-time of the first switch, by the controller circuit, when the sensed voltage is greater than the predetermined threshold.

In some embodiments, the method further includes generating a feedback signal, by the resistor network, that corresponds to the voltage at the switch node.

In some embodiments, the method further includes transmitting the feedback signal to the controller circuit.

In some embodiments, the method further includes generating, by the controller circuit, the on-time of the first switch based on the feedback signal.

In some embodiments, a circuit is disclosed. The circuit includes a transformer having a primary winding, a secondary winding and an auxiliary wining, the primary winding extending from a first terminal to a second terminal, where the auxiliary winding includes a first end and a second end; a first switch having a first gate terminal, a first source terminal and a first drain terminal, the first drain terminal connected to the first terminal; a second switch having a second gate terminal, a second source terminal and a second drain terminal, the second source terminal connected to the second terminal, and the second drain terminal connected to the first source terminal at a switch node; and a controller circuit connected to the switch node and to an out terminal of the auxiliary winding, where the controller circuit is arranged to: receive a feedback signal that corresponds to a voltage at the switch node; compare the feedback signal to a predetermined threshold; increase an on-time of the first switch when the feedback signal is less than the predetermined threshold; and decrease the on-time of the first switch when the feedback signal is greater than the predetermined threshold.

In some embodiments, the first switch is a gallium nitride (GaN)-based switch.

### BRIEF DESCRIPTION OF THE DRAWINGS

FIG. 1 illustrates a simplified schematic of an asymmetric half-bridge flyback converter with full ring valley switching, according to some embodiments;

FIG. 2 is a simplified flowchart illustrating a method of achieving full ring valley switching, according to some embodiments of the disclosure;

FIG. 3 illustrates graphs of voltages at various nodes in circuit of FIG. 1, according to some embodiments;

FIG. 4 illustrates use of the tune signal of FIG. 1 to adjust the Q1 on-time, according to some embodiments;

FIG. 5 illustrates use of the tune signal to adjust the Q1 on-time when Vsw resonant amplitude is relatively small, according to some embodiments;

FIG. 6 shows the currents flowing through Lm and Cr when Vsw resonant amplitude is relatively small, according to some embodiments;

FIG. 7 illustrates detail schematic of the Vsw detection circuit of FIG. 1, according to some embodiments;

FIG. 8 is a simplified flowchart illustrating a method of determining a value of the Vsw resonant threshold voltage, according to some embodiments of the disclosure;

FIG. 9 illustrates graphs of voltages at various nodes in circuit 100 as related to method 800, according to some embodiments;

FIG. 10 is a simplified flowchart illustrating a method of operating an AHB converter circuit in full ring valley switching, according to some embodiments of the disclosure;

FIG. 11 illustrates a schematic of an AHB converter circuit with the resonant tank on the low side using full ring valley switching, according to some embodiments;

FIG. 12 illustrates a schematic of an AHB converter circuit with the resonant tank on the high side using full ring valley switching, according to some embodiments;

FIG. 13 is a simplified flowchart illustrating a method of operating an AHB converter circuit with the resonant tank on the high side using full ring valley switching, according to some embodiments;

FIG. 14 is a simplified flowchart illustrating an alternate method of operating an AHB converter circuit with the resonant tank on the high side using full ring valley switching, according to some embodiments;

FIG. 15 illustrates graphs of voltages at various nodes in circuit 1200, according to some embodiments;

FIG. 16 is a simplified flowchart illustrating an alternate method of operating an AHB converter circuit with the resonant tank on the high side using full ring valley switching, according to some embodiments;

FIG. 17 illustrates graphs of voltages at various nodes in circuit 1200, according to some embodiments;

FIG. 18 illustrates detailed schematic of a Vsw full-ring control circuit, according to some embodiments; and

FIG. 19 illustrates detailed schematic of an alternate Vsw full-ring control circuit, according to some embodiments.

### DETAILED DESCRIPTION

Circuits, devices and related techniques disclosed herein relate generally to electronic circuits. More specifically, circuits, devices and related techniques disclosed herein relate to circuits and methods to operate power converters with full ring valley switching. In some embodiments, a controller can be arranged to continuously sense a voltage at a switch node (Vsw) of an asymmetric half-bridge (AHB) converter, and based on the sensed voltage at the switch node, control an on-time of a high-side switch (Q1) of the AHB converter. In various embodiments, the controller can be arranged to sense the voltage at the switch node when Q1 turns off and before low-side switch (Q2) turns on. The sensed voltage can be compared to a predetermined threshold. When Vsw is greater than the predetermined threshold, the on-time of Q1 may be decreased in the next switching cycle, and when Vsw is less than the predetermined threshold, the on-time of Q1 may be increased in the next switching cycle. In this way, the AHB converter can be operated using resonant voltage valley switching with full ring valley switching resulting in relatively small switching losses and reduction of electromagnetic interference (EMI). Various inventive embodiments are described herein, including methods, processes, systems, devices, and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

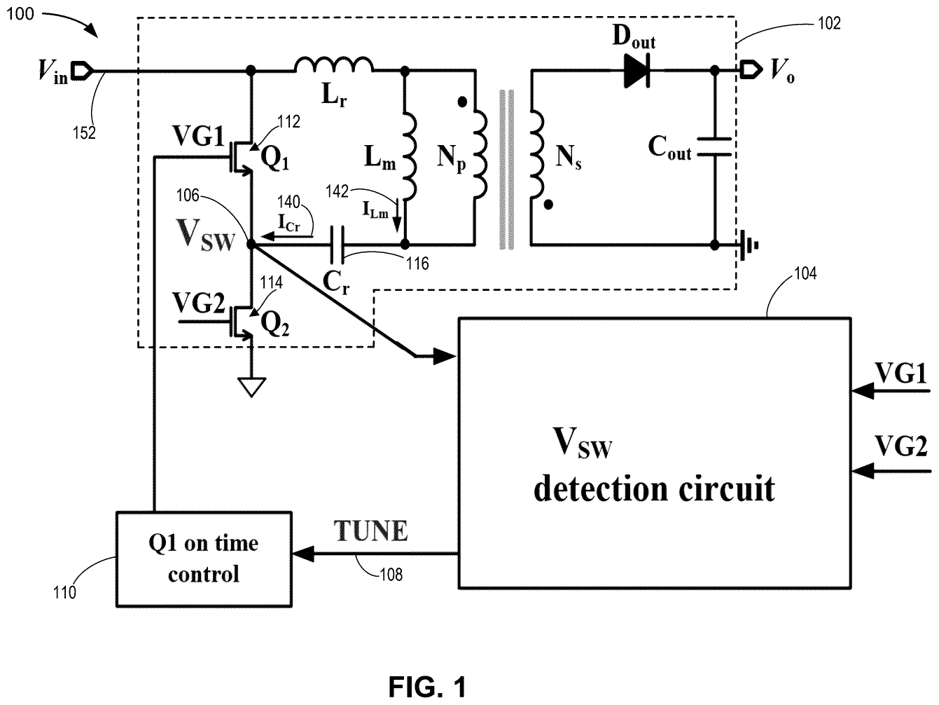

FIG. 1 illustrates a simplified schematic of an asymmetric half-bridge flyback converter with full ring valley switching, according to some embodiments. As shown in FIG. 1, circuit 100 can include an AHB flyback converter 102 coupled to a switch node voltage detection circuit 104. The switch node voltage detection circuit 104 can be coupled to the switch node 106 and can be arranged to sense a voltage at the switch node 106. The switch node voltage detection circuit 104 can be arranged to transmit a tune signal at node 108 to a high-side switch on-time control circuit 110. The high-side switch on-time control circuit 110 can be coupled to a gate terminal of high-side switch 112 (Q1). The high-side switch on-time control circuit 110 can be arranged to control an on-time of Q1. The high-side switch 112 can be coupled to a low-side switch 114 (Q2) at the switch node 106. The AHB converter 102 can also include a resonant capacitor 116 that is coupled to the switch node 106. The switch node voltage detection circuit 104 can also be coupled to the gate terminal of Q1 and to the gate terminal of Q2. Full ring implies that the switch node resonant amplitude is greater than or equal to the voltage across the resonant capacitor 116. A current flowing through the resonant capacitor is current 140 (Icr). A current flowing through Lm is current 142 (I_{Lm}). Circuit 100 can be arranged to receive an input voltage Vin at the input terminal and generate an output voltage Vo at the output terminal. In some embodiments, the first and/or the second switch can be a silicon-based switch. In various embodiments, the first and/or the second switch can be a gallium nitride (GaN)-based switch. In some embodiments, the first and/or the second switch can be a silicon carbide (SiC)-based switch.

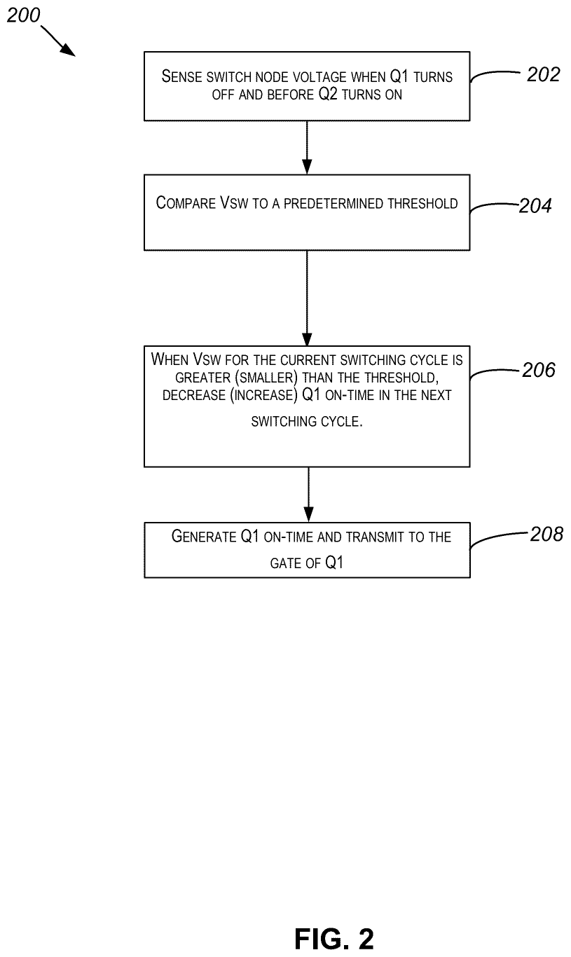

FIG. 2 is a simplified flowchart illustrating a method of achieving full ring valley switching, according to some embodiments of the disclosure. As illustrated in FIG. 2, a method of achieving full ring valley switching 200 can include sensing switch node voltage when Q1 turns off and before Q2 turns on. In this way, resonant voltage at the switch node 106 can be sensed (202). The sensed voltage can be compared to a predetermined threshold (204). Based on the comparison, an on-time of Q1 can be adjusted. When Vsw for the current switching cycle is greater than the predetermined threshold, decrease Q1 on-time in the next switching cycle. When Vsw for the current switching cycle is smaller than the threshold, increase Q1 on-time in the next switching cycle (206). The on-time of Q1 can then be generated and transmitted to the gate terminal of Q1 (208). In some embodiments, the voltage at the switch node may be sensed continuously.

It should be appreciated that the specific steps illustrated in FIG. 2 provide a particular method of achieving full ring valley switching according to an embodiment of the disclosure. Other sequences of steps may also be performed according to alternative embodiments. For example, alternative embodiments of the disclosure may perform the steps outlined above in a different order. Moreover, the individual steps illustrated in FIG. 2 may include multiple sub-steps that may be performed in various sequences as appropriate to the individual step. Furthermore, additional steps may be added or removed depending on the particular applications. One of ordinary skill in the art would recognize many variations, modifications, and alternatives.

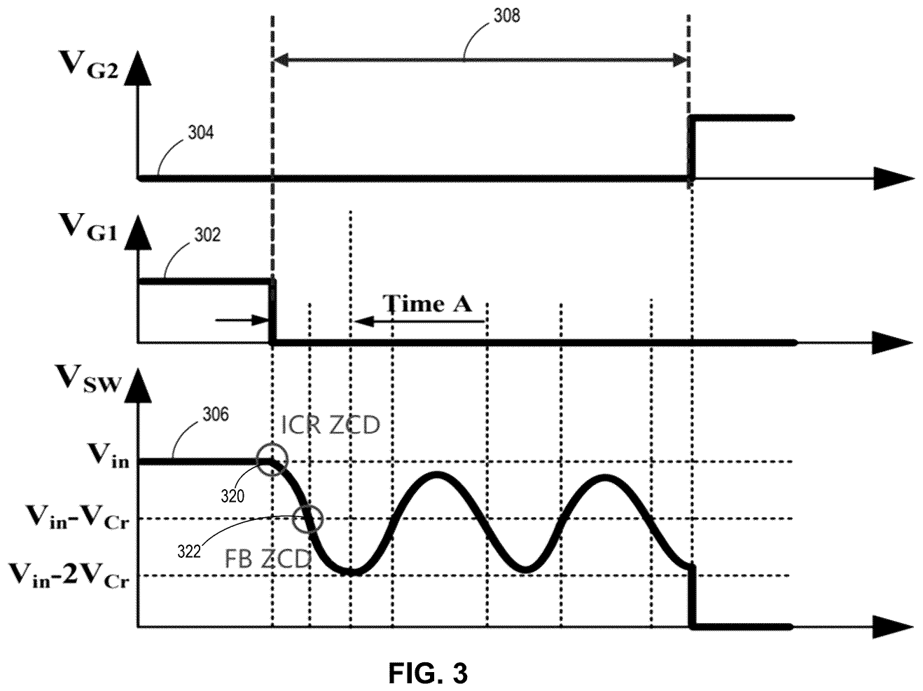

FIG. 3 illustrates graphs of voltages at various nodes in circuit 100, according to some embodiments. FIG. 3 shows the voltage 302 which is the voltage at the gate terminal of Q1, the voltage 304 at the gate terminal of Q2, and the switch node voltage 306. As shown in FIG. 3, when Q1 turns off and before Q2 turns on, the voltage at the switch node resonates. The voltage at switch node 306 is shown where a relatively good resonant waveform has been achieved after closed-loop control by the disclosed circuits and methods. The resonant amplitude of Vsw is between a voltage at Vin and Vin−2Vcr, where Vcr is a voltage across the resonant capacitor 116. When Q2 turns on, Vsw goes to zero. A deadtime 308 is shown between when Q1 turns off and when Q2 turns on. The V_{SW} resonant amplitude can be sensed during deadtime 308. The sensed V_{SW} resonant amplitude can be fed into the Vsw detection circuit 104. The Vsw detection circuit 104 can be arranged to receive the sensed V_{SW} resonant amplitude and transmit a tune signal at node 108 to a Q1 on-time control circuit 110. Based on the received tune signal at node 108, the Q1 on-time control circuit 110 can be arranged to control an on-time of Q1. The Vsw detection circuit 104 can include a comparator that is arranged to compare the sensed V_{SW} resonant amplitude to a predetermined threshold and generate and transmit the tune signal to the Q1 on-time control circuit 110. Based on the tune signal, the Q1 on-time control circuit 110 can be arranged to adjust the Q1 on-time for the next switching cycle accordingly. I_{Cr} zero crossing detection (ZCD) is indicated by 320. FB ZCD is indicated by 322.

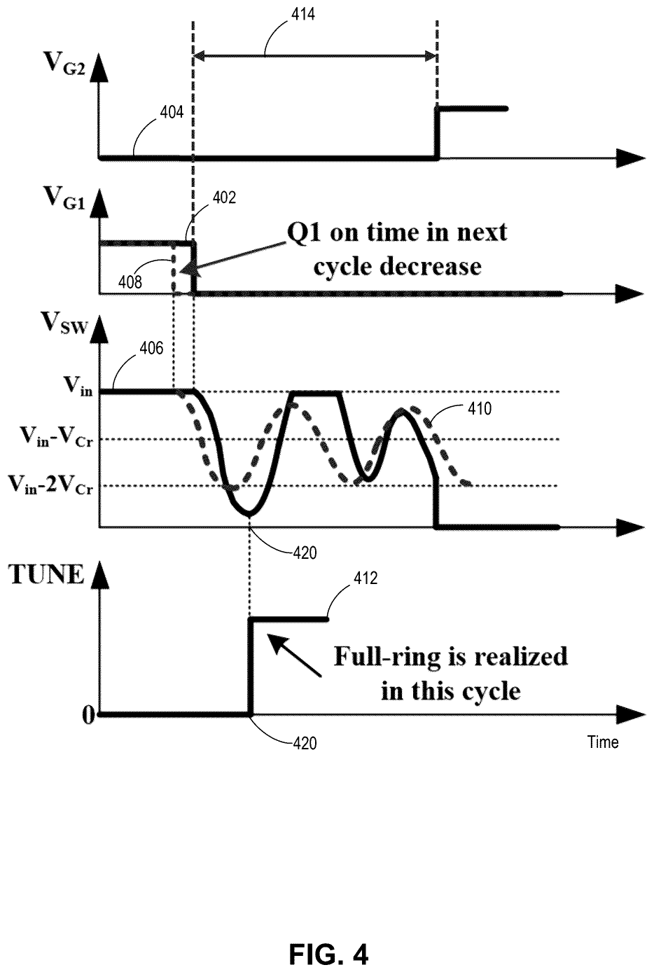

FIG. 4 illustrates use of the tune signal to adjust the Q1 on-time, according to some embodiments. FIG. 4 shows graphs of voltages at various nodes in circuit 100. Graph 402 shows the voltage at the gate terminal of Q1 at the present switching cycle, graph 404 shows the voltage at the gate terminal of Q2 at the present switching cycle, and graph 406 shows the voltage at the switch node during present switching cycle. Graph 408 shows the voltage at the gate terminal of Q1 at the next switching cycle, and graph 410 shows the voltage at the switch node during the next switching cycle. Graph 412 shows the signal Tune at node 108 as a function of time. As shown in FIG. 4, when Q1 turns off and before Q2 turns on, the voltage at the switch node resonates. 414 shows the deadtime during which the Vsw can be sensed by the Vsw detection circuit 104.

Graph 406 shows the voltage at Vsw, where during the deadtime 414 when excessive resonant amplitude is detected in the present switching cycle, the control circuit (including the Vsw detection circuit and the Q1 on-time control circuit 110) can decrease Q1 on time in the next switching cycle as shown in graph 408 and graph 410, such that the current I_{Lm} 142 is reduced thereby reducing the resonant amplitude of Vsw during the next switching cycle as shown in graph 410. As shown in graph 412, the signal Tune at node 108 is transmitted at time 420 to the Q1 on-time control circuit 110 such that during the next cycle, the Q1 on time is reduced.

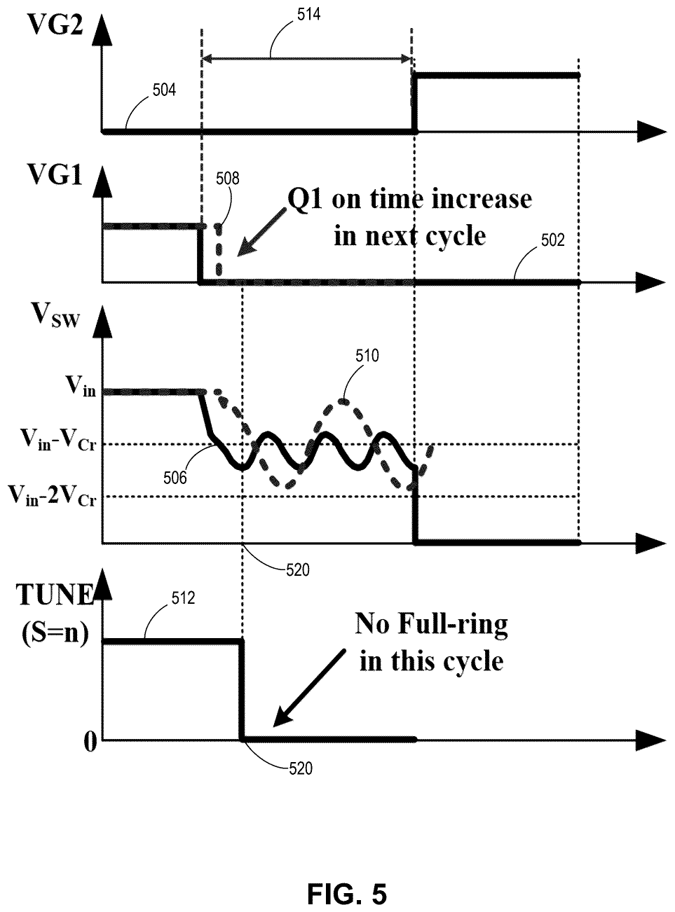

FIG. 5 illustrates use of the tune signal to adjust the Q1 on-time when Vsw resonant amplitude is relatively small, according to some embodiments. FIG. 5 shows graphs of voltages at various nodes in circuit 100. Graph 502 shows the voltage at the gate terminal of Q1 at the present switching cycle, graph 504 shows the voltage at the gate terminal of Q2 at the present switching cycle, and graph 506 shows the voltage at the switch node during present switching cycle. Graph 508 shows the voltage at the gate terminal of Q1 at the next switching cycle, and graph 510 shows the voltage at the switch node during the next switching cycle. Graph 512 shows the signal Tune at node 108 as a function of time. As shown in FIG. 5, when Q1 turns off and before Q2 turns on, the voltage at the switch node resonates. Graph 514 shows the deadtime during which the Vsw can be sensed by the Vsw detection circuit 104.

In some AHB topologies, there may exist an undesirable drop in Vsw voltage that may result in relatively small resonant amplitude of Vsw causing relatively large switching losses. This phenomenon may also occur in other topologies such as active clamp flyback (ACF) or passive clamp flyback (PCF) topologies. Circuits and methods disclosed herein can address the relatively smally Vsw resonant amplitude such that switching losses are reduced.

Graph 506 shows the voltage at Vsw, where during the deadtime 414 when the resonant amplitude of Vsw is relatively small, the control circuit (including the Vsw detection circuit 104 and the Q1 on-time control circuit 110) can increase Q1 on time in the next switching cycle as shown in graph 508 and graph 510. In this way, the resonant amplitude of Vsw can be increased during the next switching cycle as shown in graph 410. As shown in graph 412, the signal Tune at node 108 is transmitted at time 520 to the Q1 on-time control circuit 110 such that during the next cycle, the Q1 on time is increased.

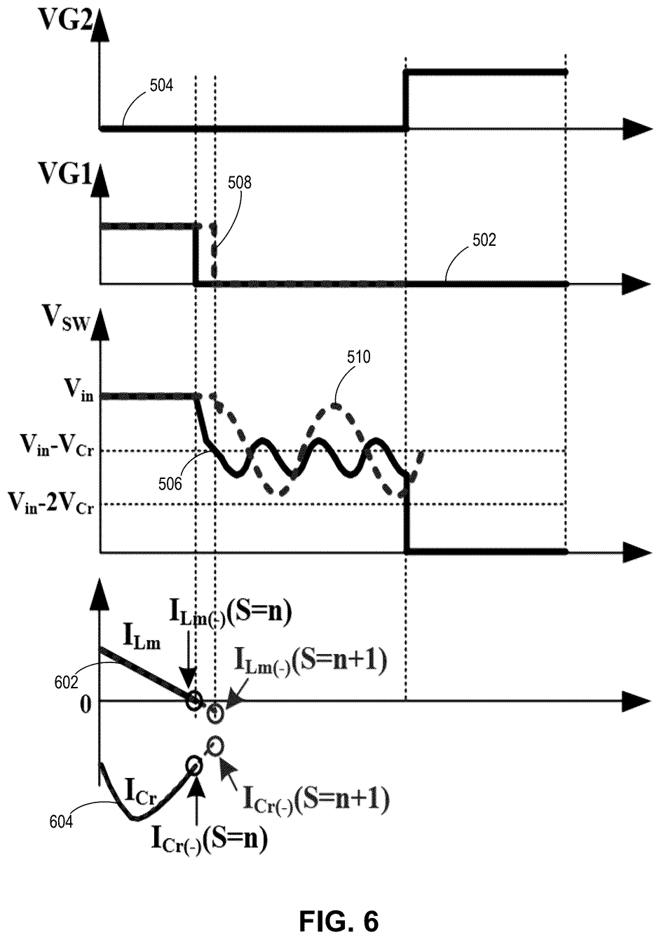

FIG. 6 shows the currents flowing through Lm and Cr when Vsw resonant amplitude is relatively small, according to some embodiments. FIG. 6 is similar to FIG. 5, with the additional graph 602 showing I_{LM} and graph 604 showing I_{Cr}. In the illustrated embodiment, there may be less energy stored in Lk, thereby less undesired V_{SW} drop caused by Lk. The current I_{Lm} in the next switching cycle may be relatively more negative, even though there is an undesired drop in V_{SW}. Because of I_{Lm} being negative, V_{SW} full-ring can be achieved.

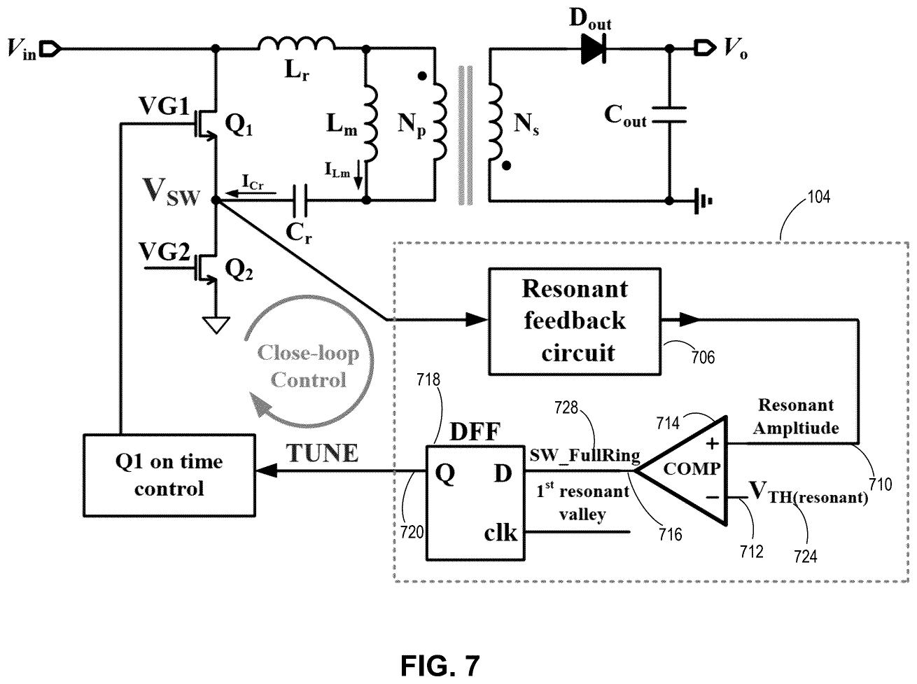

FIG. 7 illustrates detail schematic of the Vsw detection circuit of FIG. 1, according to some embodiments. As shown in FIG. 7, Vsw detection circuit 104 may include a resonant feedback circuit 706. The resonant feedback circuit 706 can be connected to the switch node 106 and can be arranged to sense the voltage at the switch node 106. The Vsw detection circuit 104 may further include a comparator 714 having a first input terminal 710 and a second input terminal 712. The first input terminal 710 can be connected to the resonant feedback circuit 706. The first input terminal 710 can be arranged to receive an output of the resonant feedback circuit 706. The second input terminal 712 may be connected to a Vsw resonant threshold voltage 724. The comparator 714 may have an output terminal 716 that is connected to a D flip-flop 718. The comparator 714 can be arranged to receive the sensed Vsw resonant voltage and compare it to the threshold voltage 724. The comparator 714 can generate an output signal 728 at the output terminal 716 based on the comparison. The output signal 728 can be transmitted to the data input terminal of the D flip-flop 718. The D flip-flop 718 can generate an output signal (Tune) at its output terminal 720 and can transmit the Tune signal to the Q1 on-time control circuit 110.

In some embodiments, the Tune signal can be a digital signal. When the Tune signal has a value of 1, it can imply that V_{SW} resonant amplitude is relatively large in the present switching cycle. Therefore, the Q1 on-time control circuit 110 may reduce the Q1 on-time in the next switching cycle. In this way, energy of Lₘ may be reduced and hence the resonant amplitude of the next cycle can be reduced. When the Tune signal has a value of 0, it can imply that V_{SW} resonant amplitude is relatively small in the present switching cycle. Therefore, the Q1 on-time control circuit 110 may increase the Q1 on-time in the next switching cycle. In this way, energy of Lₘ may be increased and hence the resonant amplitude of the next cycle can be increased.

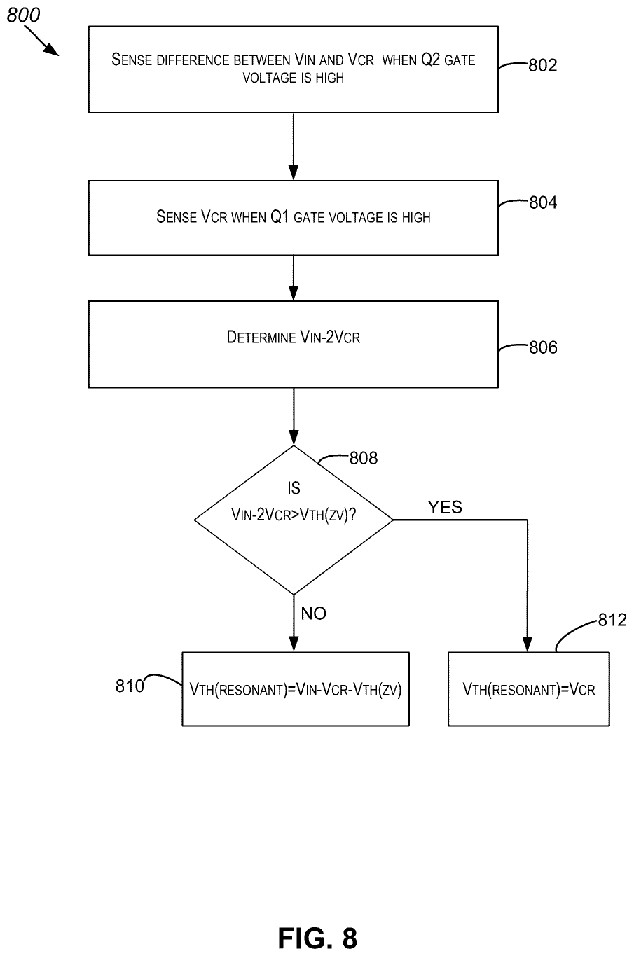

FIG. 8 is a simplified flowchart illustrating a method of determining a value of the Vsw resonant threshold voltage, according to some embodiments of the disclosure. As illustrated in FIG. 1 and FIG. 8, a method 800 of determining the value of the Vsw resonant threshold voltage can include sensing a difference between voltage at the input terminal of the AHB converter 152 (Vin) and the voltage across capacitor Cr 116 (Vcr), when a voltage at the gate terminal of Q2 is high (802). Method 800 further includes sensing Vcr when Q1 gate voltage is high (804). The method additionally includes determining value for Vin−2Vcr (806). The method also includes determining whether Vin−2Vcr is greater than Vth(zv) (808). If Vin−2Vcr is less than Vth(zv), then the value of the Vsw resonant threshold voltage is set equal to Vin−Vcr−Vth(zv) (810). If Vin−2Vcr is greater than Vth(zv), then the value of the Vsw resonant threshold voltage is set equal to Vcr (812).

It should be appreciated that the specific steps illustrated in FIG. 8 provide a particular method of determining a value of the Vsw resonant threshold voltage according to an embodiment of the disclosure. Other sequences of steps may also be performed according to alternative embodiments. For example, alternative embodiments of the disclosure may perform the steps outlined above in a different order. Moreover, the individual steps illustrated in FIG. 8 may include multiple sub-steps that may be performed in various sequences as appropriate to the individual step. Furthermore, additional steps may be added or removed depending on the particular applications. One of ordinary skill in the art would recognize many variations, modifications, and alternatives.

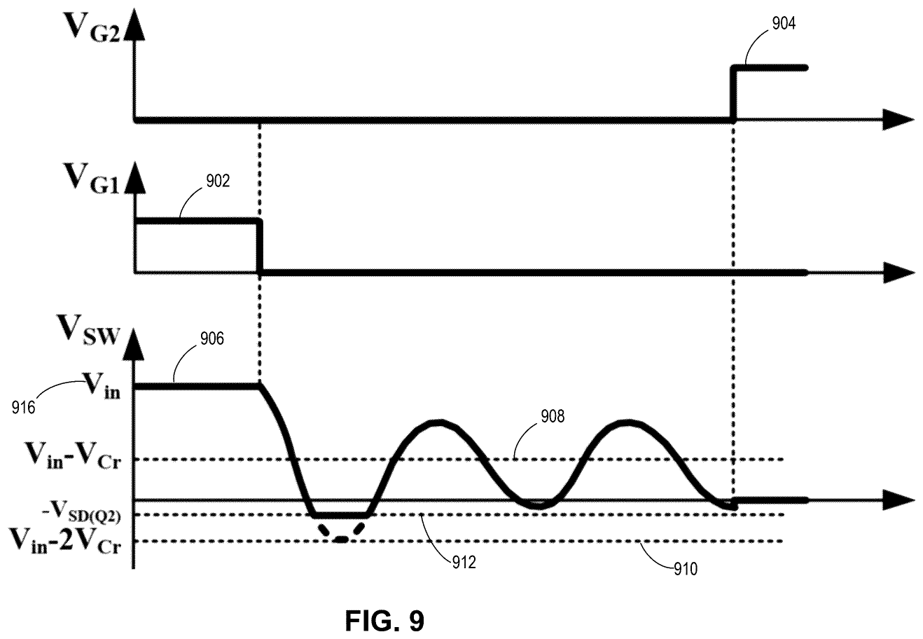

FIG. 9 illustrates graphs of voltages at various nodes in circuit 100 as related to method 800, according to some embodiments. FIG. 9 shows the voltage 902 at the gate terminal of Q1, the voltage 904 at the gate terminal of Q2, and the voltage 906 at the switch node. As shown in FIG. 9, when Q1 turns off and before Q2 turns on, the voltage at the switch node resonates. The resonant amplitude of Vsw is between a voltage at Vin 916 and Vin−2Vcr 912, where Ver is a voltage across the resonant capacitor 116. Graph 908 shows the value for Vin−Vcr. 912 shows a value of source to drain voltage of Q2 (−V_{SD})(Q2)).

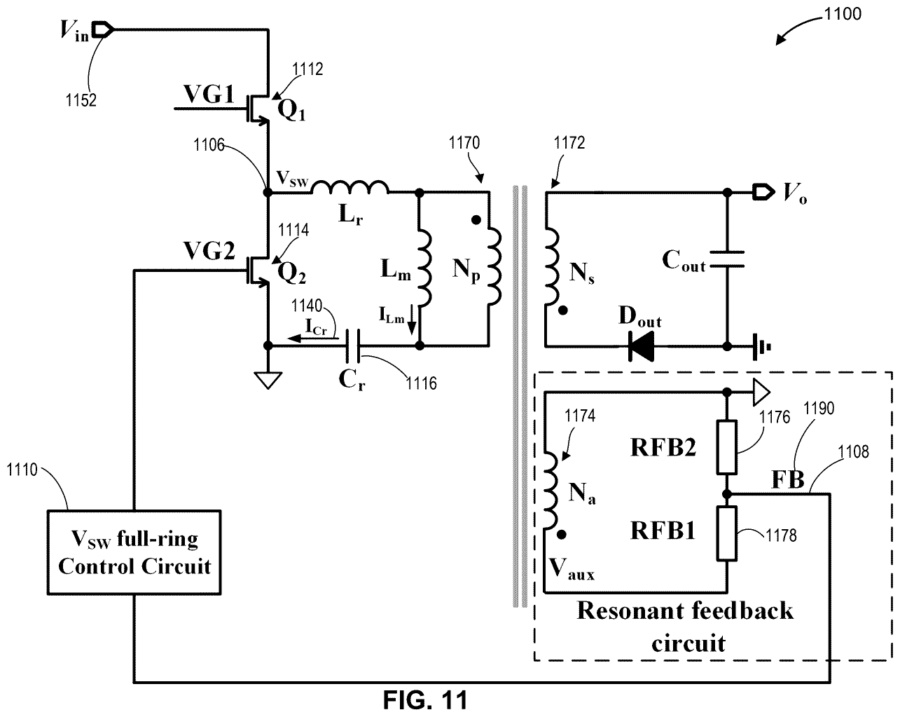

In some embodiments, when detecting full-ring resonant value of Vsw, various full-ring thresholds may be selected according to different system operating conditions. In a first operating condition where Vin−Vcr is less than Vcr, when V_{SW} is close to 0, it can indicate that full-ring condition has been achieved. As shown in FIG. 9, Vsw may be clamped to −V_{SD}(Q2). V_{SD} is the reverse voltage of Q2 when reverse current flows. In a second operating condition where Vin−Vcr is greater than Vcr, V_{SW} may be lower than V_{IN}−2V_{CR}. Referring to FIG. 11, the voltage signals can be sensed by FB 1190, which is an output of the auxiliary winding 1174.

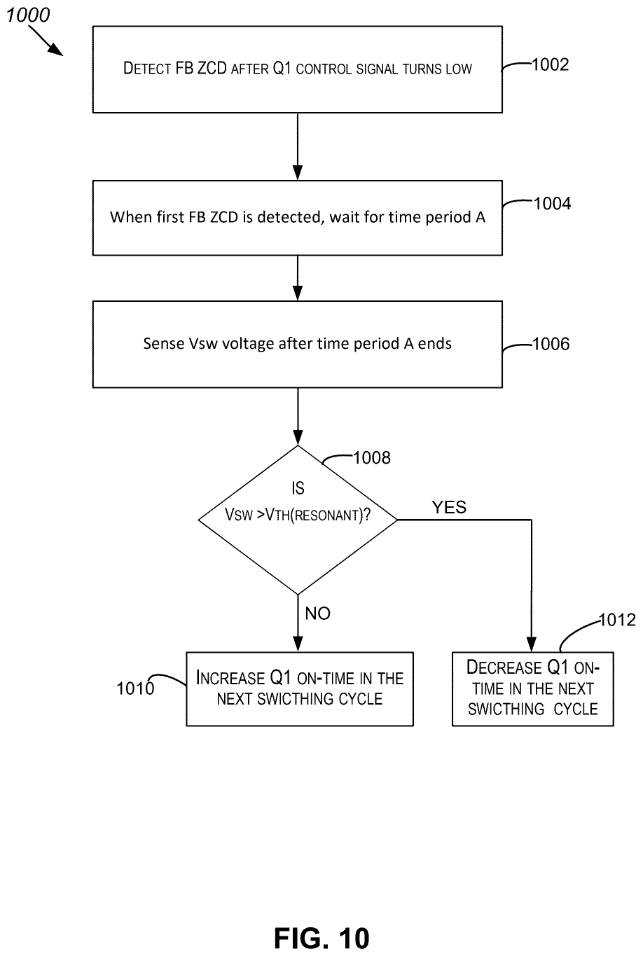

FIG. 10 is a simplified flowchart illustrating a method of operating an AHB converter circuit in full ring valley switching, according to some embodiments of the disclosure. Referring to FIG. 1, FIG. 3 and FIGS. 10-11, a method of achieving full ring valley switching 1000 can include detecting, by the Vsw detection circuit 104, feedback (FB) zero crossing detection (ZCD) after Q1 gate control signal turns low (1002). The method further includes waiting for a time period A when the first FB ZCD is detected, by the Vsw detection circuit 104 (1004). The method also includes sensing Vsw voltage, by the Vsw detection circuit 104, after the time period A ends (1006). The method additionally includes determining, by the Vsw detection circuit 104, if Vsw amplitude is greater than Vth(resonant) (1008). If Vsw amplitude is less than Vth(resonant), the Q1 on-time in the next switching cycle can be increased, by the Q1 on-time control circuit 110 (1010). If Vsw amplitude is greater than Vth(resonant), the Q1 on-time in the next switching cycle can be decreased, by the Q1 on-time control circuit 110 (1012). It is noted that FB ZCD refers to the point when V_{SW} crosses V_{IN}−V_{CR}. The FB signal can be sensed on the auxiliary side 1174. In some embodiments, when V_{SW} crosses V_{IN}−V_{CR}, the voltage across the transformer may be 0. Thus, the output of the AUX winding may also be 0. Thus, zero crossing point of FB signal can be detected.

It should be appreciated that the specific steps illustrated in FIG. 10 provide a particular method of operating an AHB converter in full ring valley switching according to an embodiment of the disclosure. Other sequences of steps may also be performed according to alternative embodiments. For example, alternative embodiments of the disclosure may perform the steps outlined above in a different order. Moreover, the individual steps illustrated in FIG. 10 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 11 illustrates a schematic of an AHB converter circuit with the resonant tank on the low side using full ring valley switching, according to some embodiments. As shown in FIG. 11, circuit 1100 can include a primary side winding 1170 and a secondary side winding 1172, and an auxiliary winding 1174. An input terminal 1152 having a voltage Vin can be connected to a high-side switch 1112 (Q1). The high-side switch 1112 can be connected to a low-side switch 1114 at a switch node 1106. A source terminal of the low-side switch 1114 can be connected to the ground and to a resonant capacitor 1116. A resonant capacitor current 1140 can be flowing through the resonant capacitor 1116. The auxiliary winding 1174 can be connected to a resistor 1176 and resistor 1178. Resistor 1176 and 1178 can be arranged to sense a current in the primary side that is indicative of the switch node voltage, and generate a feedback signal 1190 (FB) at node 1108. The feedback signal can be transmitted to a Vsw full-ring control circuit 1110. The feedback signal can be transmitted to a Vsw full-ring control circuit 1110 that can be arranged to control the low-side switch 1114 based on the received FB signal. When the sensed Vsw amplitude is less than a resonant threshold value, the Q2 on-time can be increased in the next switching cycle. When the sensed Vsw amplitude is greater than the resonant threshold value, the Q2 on-time can be reduced in the next switching cycle. In this way, full-ring valley switching can be achieved resulting in reduced switching losses.

In some embodiments, by increasing the conduction time of Q2, Lm may have a relatively larger negative current, and by reducing the conduction time of Q2, the negative current of Lm may have a relatively smaller negative current. In various embodiments, during the conduction duration of Q2, Lm may be in the de-magnetization condition, therefore the current may be reduced. When the current crosses 0, it may continue to have a negative value. The longer the conduction time of Q2, the greater the negative current. When the sampled resonance amplitude of switch node is relatively small, embodiment of the disclosure can provide a relatively larger initial kinetic energy for the LC tank by providing Lm with a larger negative current. In this way, a larger resonance amplitude can be achieved, and vice versa.

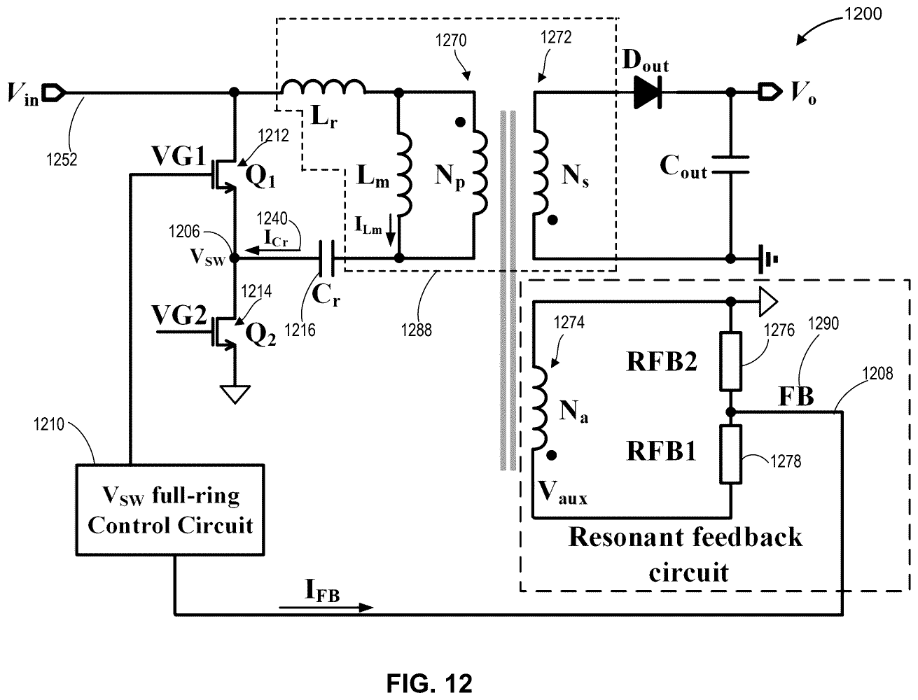

FIG. 12 illustrates a schematic of an AHB converter circuit with the resonant tank on the high side using full ring valley switching, according to some embodiments. As shown in FIG. 12, circuit 1200 can include a transformer 1288 having a primary side winding 1270 and a secondary side winding 1272, and an auxiliary winding 1274. An input terminal 1252 having a voltage Vin can be connected to a high-side switch 1212 (Q1). The high-side switch 1212 can be connected to a low-side switch 1214 at a switch node 1206. A source terminal of the high-side switch can be connected to a resonant capacitor 1216. A resonant capacitor current 1240 can be flowing through the resonant capacitor 1216. The auxiliary winding 1274 can be connected to a resistor 1276 and resistor 1278. Resistors 1276 and 1278 can be arranged to sense a current in the primary side that is indicative of the switch node voltage, and generate a feedback signal 1290 (FB) at node 1208. The feedback signal can be transmitted to a Vsw full-ring control circuit 1210. In some embodiments, the feedback signal can be a current I_{FB}. The feedback signal can be transmitted to a Vsw full-ring control circuit 1210 that can be arranged to control the high-side switch 1212 based on the received FB signal. When the sensed Vsw amplitude is less than a resonant threshold value, the Q1 on-time can be increased in the next switching cycle. When the sensed Vsw amplitude is greater than the resonant threshold value, the Q1 on-time can be reduced in the next switching cycle. In this way, full-ring valley switching can be achieved resulting in reduced switching losses.

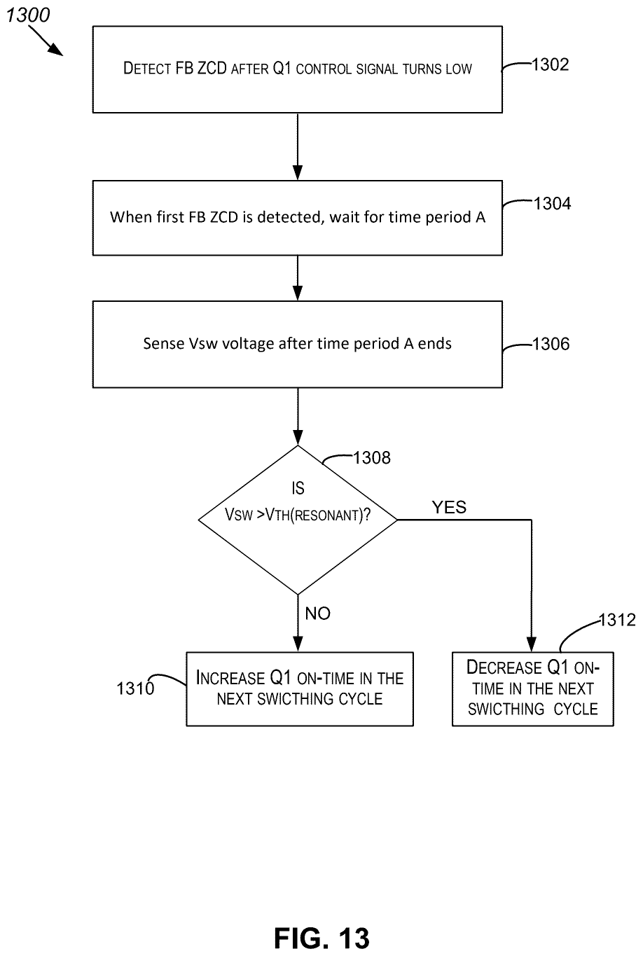

FIG. 13 is a simplified flowchart illustrating a method of operating an AHB converter circuit with the resonant tank on the high side using full ring valley switching, according to some embodiments. Referring to FIG. 12 and FIG. 13, a method of achieving full ring valley switching 1300 can include detecting a feedback (FB) zero crossing detection (ZCD) after Q1gate control signal turns low (1302). The method further includes waiting for a time period A when the first FB ZCD is detected, by the Vsw full-ring control circuit 1210 (1304). In some embodiments, time A can be programmed by an off-chip resistor. In various embodiments, time A can be equal to 25% of the resonant time of Lm and Csw. In various embodiments, the method includes waiting for a time period A when the second FB ZCD is detected (1304). The method also includes sensing Vsw voltage, after the time period A ends (1306). The method additionally includes determining if Vsw amplitude is greater than Vth(resonant) (1308). In some embodiments, Vsw resonant amplitude may be equal to (Vin−Vcr)−Vsw(t0). If Vsw amplitude is less than Vth(resonant), the Q1 on-time in the next switching cycle can be increased (1310). If Vsw amplitude is greater than Vth(resonant), the Q1 on-time in the next switching cycle can be decreased (1312).

It should be appreciated that the specific steps illustrated in FIG. 13 provide a particular method of operating an AHB converter with a high-side resonant tank in full ring valley switching according to an embodiment of the disclosure. Other sequences of steps may also be performed according to alternative embodiments. For example, alternative embodiments of the disclosure may perform the steps outlined above in a different order. Moreover, the individual steps illustrated in FIG. 13 may include multiple sub-steps that may be performed in various sequences as appropriate to the individual step. Furthermore, additional steps may be added or removed depending on the particular applications. One of ordinary skill in the art would recognize many variations, modifications, and alternatives.

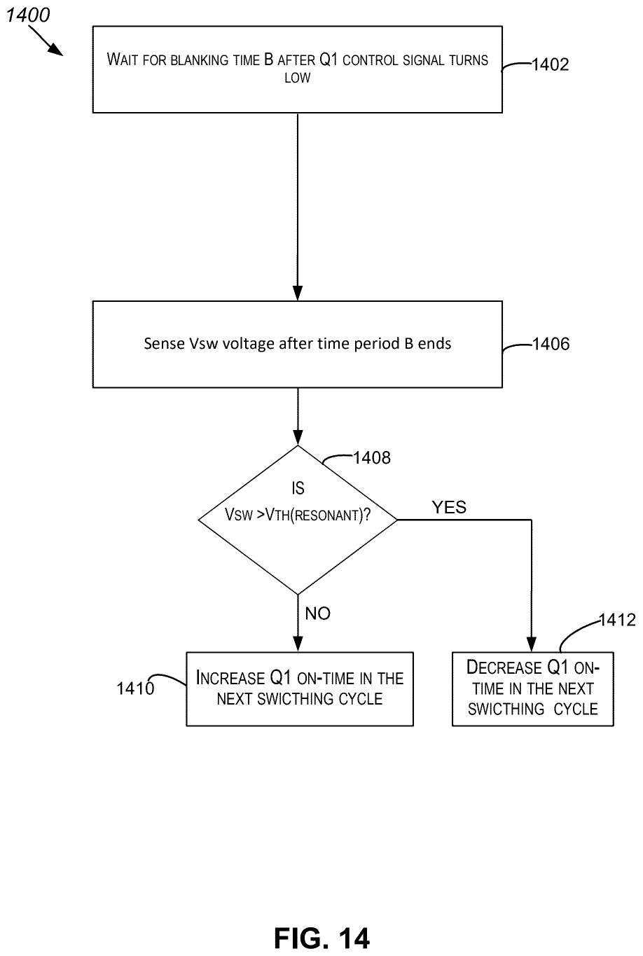

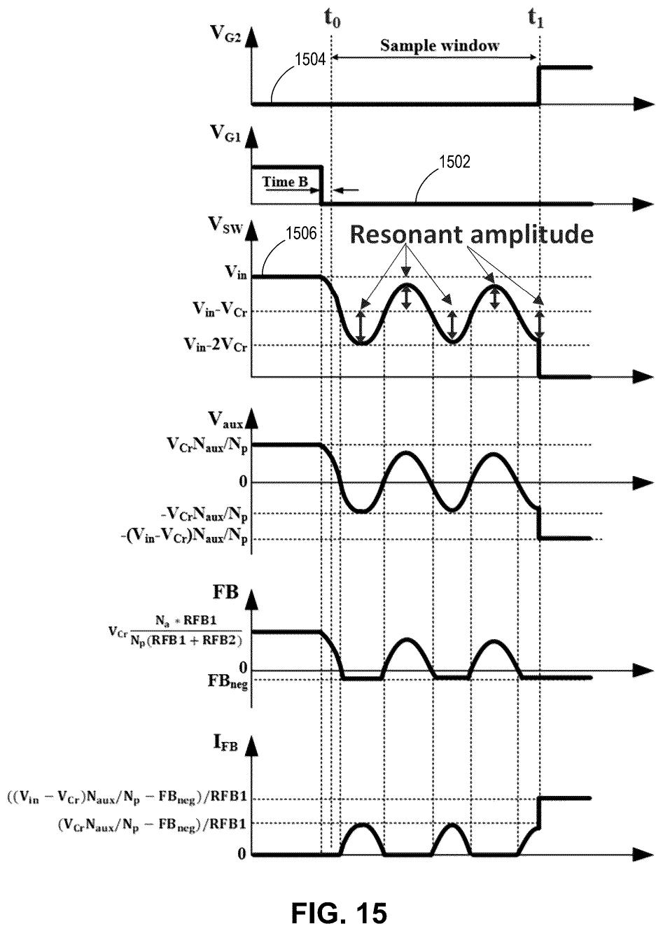

FIG. 14 is a simplified flowchart illustrating an alternate method of operating an AHB converter circuit with the resonant tank on the high side using full ring valley switching, according to some embodiments. Referring to FIG. 12, FIG. 14 and FIG. 15, a method of achieving full ring valley switching 1400 can include waiting for a blanking time period B after Q1 gate control signal turns low (1402). The method also includes sensing Vsw voltage after the time period B ends (1406). In some embodiments, a disclosed controller circuit can sample any valley/peak of V_{SW} before Q2 is turned on. The method additionally includes determining if Vsw amplitude is greater than Vth(resonant) (1408). In some embodiments, Vsw resonant amplitude may be equal to (Vin−Vcr)−Vsw(t0). If Vsw amplitude is less than Vth(resonant), the Q1 on-time in the next switching cycle can be increased (1410). If Vsw amplitude is greater than Vth(resonant), the Q1 on-time in the next switching cycle can be decreased (1412).

It should be appreciated that the specific steps illustrated in FIG. 14 provide a particular method of operating an AHB converter with a high-side resonant tank in full ring valley switching according to an embodiment of the disclosure. Other sequences of steps may also be performed according to alternative embodiments. For example, alternative embodiments of the disclosure may perform the steps outlined above in a different order. Moreover, the individual steps illustrated in FIG. 14 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 15 illustrates graphs of voltages at various nodes in circuit 1200, according to some embodiments. FIG. 15 shows the voltage 1502 at the gate terminal of Q1, the voltage 1504 at the gate terminal of Q2, and the voltage 1506 at the switch node, and various other voltages.

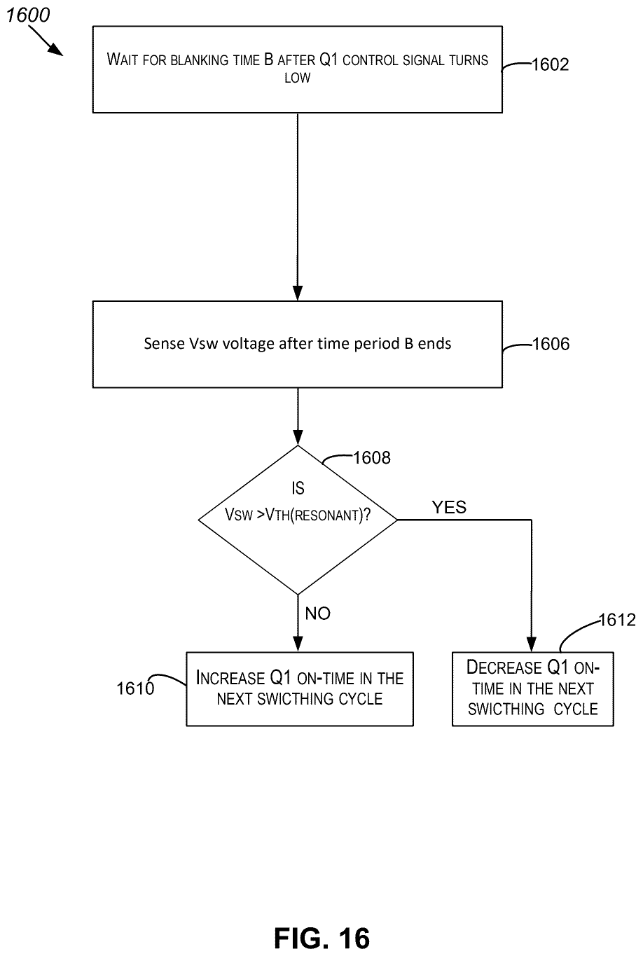

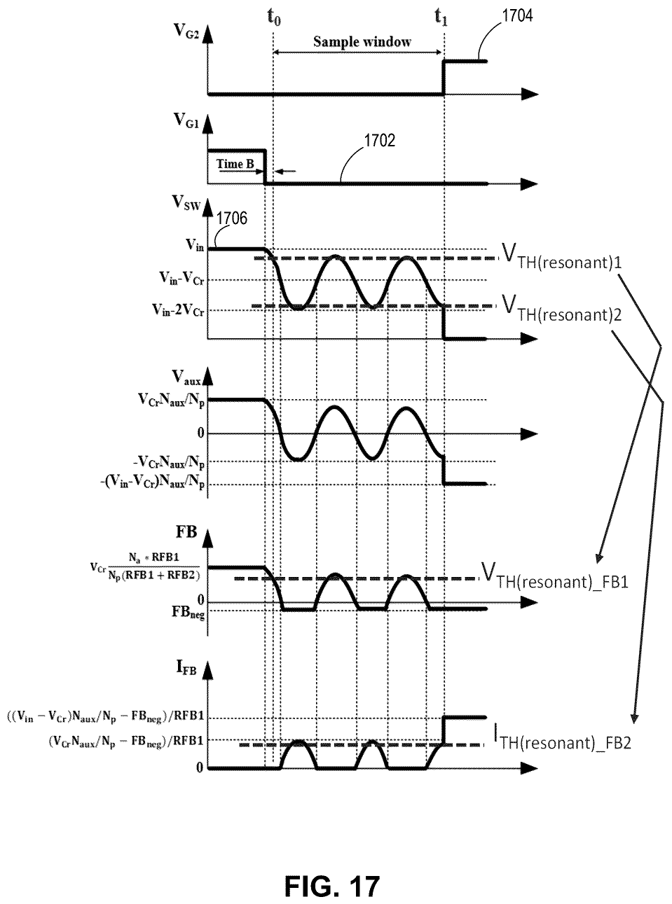

FIG. 16 is a simplified flowchart illustrating an alternate method of operating an AHB converter circuit with the resonant tank on the high side using full ring valley switching, according to some embodiments. Referring to FIG. 12, FIG. 16 and FIG. 17, a method of achieving full ring valley switching 1600 can include waiting for a blanking time period B after Q1 gate control signal turns low (1602). The method also includes sensing Vsw voltage after the time period B ends (1606). In some embodiments, a disclosed controller circuit can sample any valley/peak of V_{SW} before Q2 is turned on. In various embodiments, a sensing window may start after FB signal first zero crossing detection. The method additionally includes determining if Vsw amplitude is greater than Vth(resonant) (1608). In some embodiments, within the sensing window, when Vsw amplitude is sensed to be above the threshold, it may be considered a full-ring. This can be a continuous sensing for the time window, rather than sensing at a specific point in time. If Vsw amplitude is less than Vth(resonant), the Q1 on-time in the next switching cycle can be increased (1610). If Vsw amplitude is greater than Vth(resonant), the Q1 on-time in the next switching cycle can be decreased (1612).

It should be appreciated that the specific steps illustrated in FIG. 16 provide a particular method of operating an AHB converter with a high-side resonant tank in full ring valley switching according to an embodiment of the disclosure. Other sequences of steps may also be performed according to alternative embodiments. For example, alternative embodiments of the disclosure may perform the steps outlined above in a different order. Moreover, the individual steps illustrated in FIG. 16 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 17 illustrates graphs of voltages at various nodes in circuit 1200, according to some embodiments. FIG. 17 shows the voltage at the gate terminal of Q1 1702, the voltage at the gate terminal of Q2 1704, and the voltage at the switch node 1706, and various other voltages.

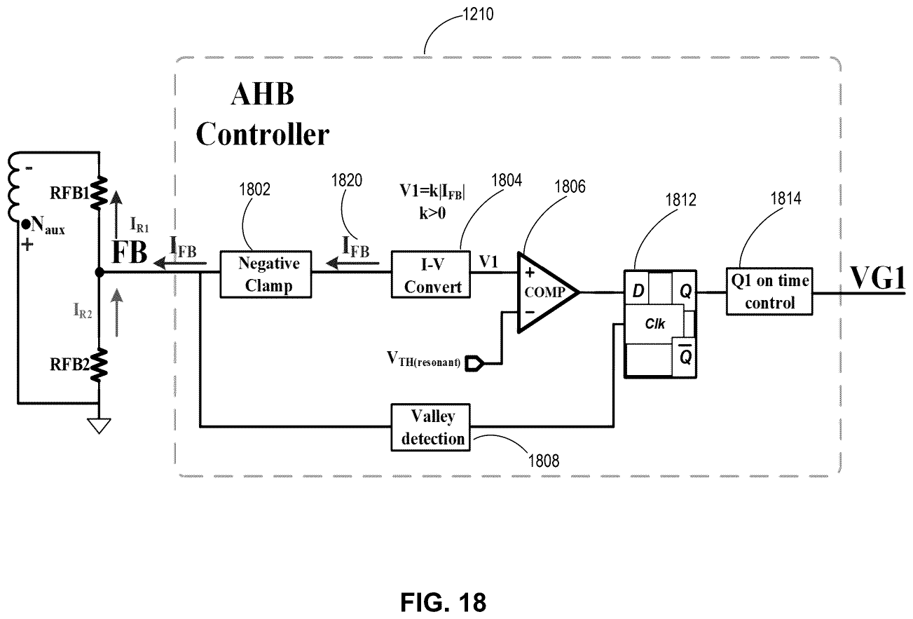

FIG. 18 illustrates detailed schematic of a Vsw full-ring control circuit, according to some embodiments. As shown in FIG. 18, the Vsw full-ring control circuit 1210 can include a negative clamp circuit 1802 that is connected to an I-V conversion circuit 1804. The Vsw full-ring control circuit 1210 can additionally include a comparator 1806 that is connected to the I-V conversion circuit 1804. The output terminal of the comparator can be connected to a D flip-flop 1812. An output terminal of the D flip-flop 1812 can be connected to a Q1 on-time control circuit 1814. An input terminal of the negative clamp circuit 1802 can be connected to the node 1208 and can be arranged to transmit feedback current I_{FB} 1820 to the auxiliary side of the AHB converter circuit. The Vsw full-ring control circuit 1210 can also include a valley detection circuit 1808 that is connected to the comparator 1806 and to the input terminal of the negative clamp circuit 1802. The valley detection circuit 1808 can be arranged to detect the valley in the Vsw signal. The I-V conversion circuit 1804 can be arranged to convert current to voltage. In some embodiments, the I-V conversion circuit 1804 can have transfer function V=k|I_{FB}| where k>0. The comparator 1806 can be arranged to compare the sensed Vsw voltage and compare it to a predetermined threshold. In some embodiments, the predetermined threshold is Vth(resonant). Based on the comparison, the comparator 1806 can transmit a signal to the D flip-flop 1812. The D flip-flop 1812 can correspondingly transmit a signal to the Q1 on-time control to control the gate terminal of the Q1 such that the Q1 on time can be adjusted. Thus:

$$Resonant amplitude = ( {V}_{in} - {V}_{Cr} ) - {V}_{SW} ( {t}_{0} ) = - {V}_{aux} \frac{{N}_{p}}{{N}_{aux}}$$

$$FB is clamped to ZCDneg \approx 0 , thus {I}_{R 2} \approx 0 ,$$

$${I}_{FB} ( {t}_{0} ) \approx {I}_{R 1} ( {t}_{0} ) \approx \frac{{N}_{aux}}{( {N}_{p} RFB 1 ) ( Resonant amplitude )}$$

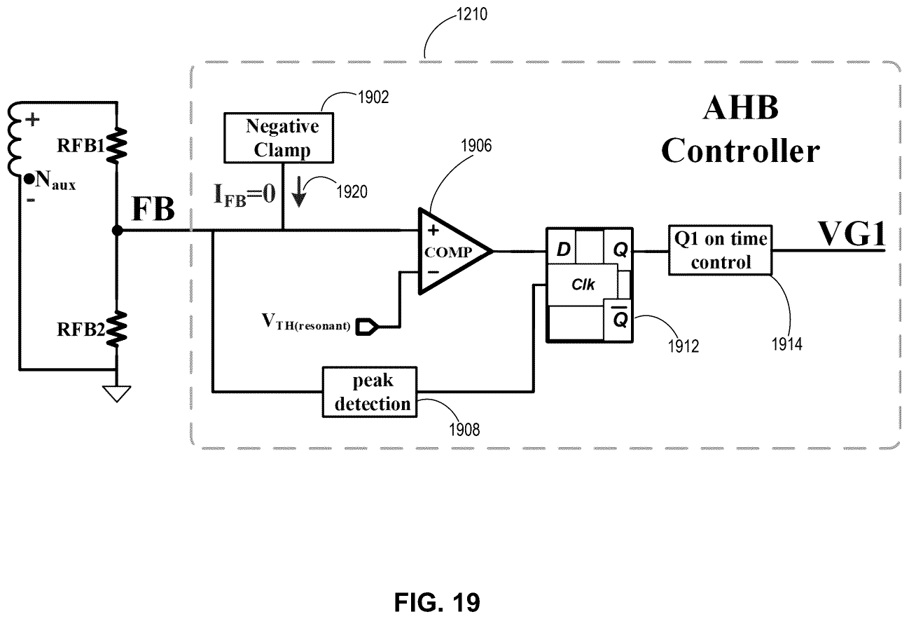

FIG. 19 illustrates detailed schematic of an alternate Vsw full-ring control circuit, according to some embodiments. As shown in FIG. 19, the Vsw full-ring control circuit 1210 can include a negative clamp circuit 1902. The Vsw full-ring control circuit 1210 can additionally include a comparator 1906 that is connected to the negative clamp circuit 1902. The output terminal of the comparator can be connected to a D flip-flop 1912. An output terminal of the D flip-flop 1912 can be connected to a Q1 on-time control circuit 1914. An input terminal of the negative clamp circuit 1902 can be connected to the node 1208 and can be arranged to transmit feedback current I_{FB} 1920 to the auxiliary side of the AHB converter circuit. The Vsw full-ring control circuit 1210 can also include a peak detection circuit 1908 that is connected to the comparator 1906 and to the input terminal of the negative clamp circuit 1902. The peak detection circuit 1908 can be arranged to detect the peak in the Vsw signal. The comparator 1906 can be arranged to compare the sensed Vsw voltage and compare it to a predetermined threshold. In some embodiments, the predetermined threshold is Vth(resonant). Based on the comparison, the comparator 1906 can transmit a signal to the D flip-flop 1912. The D flip-flop 1912 can correspondingly transmit a signal to the Q1 on-time control to control the gate terminal of the Q1 such that the Q1 on time can be adjusted. Thus:

$$Resonant amplitude = {V}_{SW} ( {t}_{0} ) - ( {V}_{in} - {V}_{Cr} ) = {V}_{aux} \frac{{N}_{p}}{{N}_{aux}}$$

$$FB = \frac{{N}_{aux}}{{N}_{p}} \frac{RFB 2}{( RFB 1 + RFB 2 ) ( Resonant amplitude )}$$

In some embodiments, combination of the circuits and methods disclosed herein can be utilized to provide circuits and methods to operate power converters with full ring valley switching. Although circuits and methods are described and illustrated herein with respect to several particular configuration of an AHB converter circuit, embodiments of the disclosure are suitable for use with other power converter topologies such as, but not limited to, active/passive clamp flyback (ACF/PCF) converter circuits and inductor-inductor-capacitor (LLC) half-bridge LLC converters

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A circuit comprising:
a transformer having a primary winding and a secondary winding, the primary winding extending from a first terminal to a second terminal;
a first switch having a first gate terminal, a first source terminal and a first drain terminal, the first drain terminal connected to the first terminal;
a second switch having a second gate terminal, a second source terminal and a second drain terminal, the second source terminal connected to the second terminal, and the second drain terminal connected to the first source terminal at a switch node; and
a controller circuit connected to the switch node and arranged to:
sense a voltage at the switch node;
compare the sensed voltage to a predetermined threshold;
increase an on-time of the first switch when the sensed voltage is less than the predetermined threshold; and
decrease the on-time of the first switch when the sensed voltage is greater than the predetermined threshold.

2. The circuit of claim 1, further comprising a capacitor connected between the second drain terminal and the second terminal.

3. The circuit of claim 2, wherein a first terminal voltage is indicated by Vin, a resonant switch node voltage is indicated by Vsw and a capacitor voltage is indicated by Vcr, and wherein the controller circuit is further arranged to keep Vsw between Vin and Vin−2Vcr.

4. The circuit of claim 1, wherein the controller circuit comprises a switch node detection circuit and a switch on-time control circuit.

5. The circuit of claim 4, wherein the switch node detection circuit is arranged to generate a first signal based on the comparison and transmit the first signal to the switch on-time control circuit.

6. The circuit of claim 1, wherein the transformer further comprises an auxiliary winding having a first end and a second end, wherein the first end is connected to a ground and the second end is connected to a resistor network.

7. The circuit of claim 6, wherein the resistor network is arranged to generate a feedback signal that corresponds to the voltage at the switch node.

8. The circuit of claim 7, wherein the feedback signal is transmitted to the controller circuit and wherein the controller circuit generates the on-time of the first switch based on the feedback signal.

9. A method operating a circuit, the method comprising:
providing a transformer having a primary winding and a secondary winding, the primary winding extending from a first terminal to a second terminal;
providing a first switch having a first gate terminal, a first source terminal and a first drain terminal, the first drain terminal connected to the first terminal;
providing a second switch having a second gate terminal, a second source terminal and a second drain terminal, the second source terminal connected to the second terminal, and the second drain terminal connected to the first source terminal at a switch node; and
sensing, by a controller circuit, a voltage at the switch node;
comparing, by the controller circuit, the sensed voltage to a predetermined threshold;
increasing an on-time of the first switch, by the controller circuit, when the sensed voltage is less than the predetermined threshold; and
decrease the on-time of the first switch, by the controller circuit, when the sensed voltage is greater than the predetermined threshold.

10. The method of claim 9, further comprising providing a capacitor connected between the second drain terminal and the second terminal.

11. The method of claim 10, wherein a first terminal voltage is indicated by Vin, a resonant switch node voltage is indicated by Vsw and a capacitor voltage is indicated by Vcr, and wherein the controller circuit is further arranged to keep Vsw between Vin and Vin−2Vcr.

12. The method of claim 9, wherein the transformer further comprises an auxiliary winding having a first end and a second end, wherein the first end is connected to a ground and the second end is connected to a resistor network.

13. The method of claim 12, further comprising generating a feedback signal, by the resistor network, that corresponds to the voltage at the switch node.

14. The method of claim 13, further comprising transmitting the feedback signal to the controller circuit.

15. The method of claim 14, further comprising generating, by the controller circuit, the on-time of the first switch based on the feedback signal.

16. A circuit comprising:
a transformer having a primary winding, a secondary winding and an auxiliary wining, the primary winding extending from a first terminal to a second terminal, wherein the auxiliary winding includes a first end and a second end;
a first switch having a first gate terminal, a first source terminal and a first drain terminal, the first drain terminal connected to the first terminal;
a second switch having a second gate terminal, a second source terminal and a second drain terminal, the second source terminal connected to the second terminal, and the second drain terminal connected to the first source terminal at a switch node; and
a controller circuit connected to the switch node and to an out terminal of the auxiliary winding, wherein the controller circuit is arranged to:
receive a feedback signal that corresponds to a voltage at the switch node;
compare the feedback signal to a predetermined threshold;
increase an on-time of the first switch when the feedback signal is less than the predetermined threshold; and
decrease the on-time of the first switch when the feedback signal is greater than the predetermined threshold.

17. The circuit of claim 16, further comprising a capacitor connected between the second drain terminal and the second terminal.

18. The circuit of claim 17, wherein a first terminal voltage is indicated by Vin, a resonant switch node voltage is indicated by Vsw and a capacitor voltage is indicated by Vcr, and wherein the controller circuit is further arranged to keep Vsw between Vin and Vin−2Vcr.

19. The circuit of claim 16, wherein the controller circuit comprises a switch node detection circuit and a switch on-time control circuit.

20. The circuit of claim 16, wherein the first switch is a gallium nitride (GaN)-based switch.
